(19) United States
(12) Patent Application Publication
(10) Pub. No.: US 2012/0203565 A1
(43) Pub. Date: Aug. 9, 2012

(54) METHOD AND APPARATUS FOR PROVIDING IMPROVED PATIENT MEDICATION ADHERENCE

(75) Inventors: Ilene Hollin, New York, NY (US); Stan Kachnowski, New York, NY (US); Biran Bertha, Danville, CA (US)

(73) Assignee: McKesson Specialty Arizona Inc.

(21) Appl. No.: 13/022,248

(22) Filed: Feb. 7, 2011

(51) Int. Cl. G06Q 50/00; G06Q 30/00

(52) U.S. Cl. 705/2; 705/14.1

(57) ABSTRACT

A method for providing improved patient medication adherence may include utilizing claims data indicative of past prescription claims to identify a candidate for an enhanced interview with a care professional in connection with prescription medication therapy, and initiating communication with the care professional to direct the care professional to conduct the enhanced interview with the candidate in connection with delivery of the prescription medication therapy to the candidate. A corresponding computer program product and apparatus are also provided.

### TECHNOLOGICAL FIELD

Embodiments of the present invention relate generally to health care management solutions and, more particularly, relate to the provision of a mechanism by which to improve medication adherence for patients.

### BACKGROUND

Many aspects of the provision of medical care and the management of many aspects of the healthcare system now involve the use of computers and computer applications. For example, recent efforts have been made to move to electronic medical records (EMR). With clinical documentation systems moving to electronic media, clinical data may be available for incorporation into a number of different applications designed to assist in the management or use of such data. Computerized physician order entry (CPOE) is another example of a development that may improve the ability to electronically access information related to physician's orders. Many other applications are also being developed to utilize electronic information on people and processes to manage the provision of various aspects of patient care including personal health records, health risk assessments and automated interactive voice response calling systems which are intended to reinforce positive behavior in a variety of actors in healthcare.

As the availability of electronic clinical data is increasing, the demand for applications that utilize such data to provide information, guidance and services is also increasing. Many applications have been developed to assist hospitals, clinics, doctors, insurance companies, and other healthcare related service providers with various aspects of improving patient care and organizational management. However, in many cases, regardless of the ability of a healthcare related service provider to streamline their own information management and internal processes, the overall success of any healthcare plan also relies largely on creating and reinforcing positive behaviors by various particpants (e.g. patients, physicians, care givers, etc.). Thus, efforts to influence positive change are often dependent upon behavior, which may be outside of the control of healthcare service providers.

Many efforts to influence positive change involve sending messages or reminders to patients, providers and other particpants in a one-size-fits-all mentality. However, the effects of these types of messages may not be clear and therefore, their value may not be determinable. Accordingly, it may be desirable to provide a mechanism by which to improve the intended behaviors expected of the recipient.

### BRIEF SUMMARY

A method, apparatus and computer program product are therefore provided to enable the provision of improved medication adherence. Accordingly, for example, some embodiments may provide for facilitating an enhanced interview with a patient selected as a candidate to receive such an interview. The enhanced interview may be targeted to increasing the likelihood of patient medication adherence. Patients may be selected as candidates based on pharmacy and/or medical claims data.

In one exemplary embodiment, a method for providing improved patient medication adherence is provided. The method may include utilizing claims data indicative of past prescription claims to identify a candidate for an enhanced interview with a care professional in connection with prescription medication therapy, and initiating communication with the care professional to direct the care professional to conduct the enhanced interview with the candidate in connection with delivery of the prescription medication therapy to the candidate.

In another exemplary embodiment, a computer program product for providing improved patient medication adherence is provided. The computer program product may include at least one computer-readable storage medium having computer-executable program code instructions stored therein. The computer-executable program code instructions may include program code instructions for utilizing claims data indicative of past prescription claims to identify a candidate for an enhanced interview with a care professional in connection with prescription medication therapy, and initiating communication with the care professional to direct the care professional to conduct the enhanced interview with the candidate in connection with delivery of the prescription medication therapy to the candidate.

In another exemplary embodiment, an apparatus for providing improved patient medication adherence is provided. The apparatus may include processing circuitry. The processing circuitry may be configured for utilizing claims data indicative of past prescription claims to identify a candidate for an enhanced interview with a care professional in connection with prescription medication therapy, and initiating communication with the care professional to direct the care professional to conduct the enhanced interview with the candidate in connection with delivery of the prescription medication therapy to the candidate.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram illustrating a system for providing improved patient medication adherence according to an exemplary embodiment of the present invention;

FIG. 2 is a block diagram showing various components that may be included in an apparatus for providing improved patient medication adherence according to an exemplary embodiment of the present invention; and

FIG. 3 is a block diagram according to a method for providing improved patient medication adherence according to an exemplary embodiment of the present invention.

### DETAILED DESCRIPTION

Embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein; rather, these embodiments are provided so that this disclosure will satisfy applicable legal requirements. Like reference numerals refer to like elements throughout.

As indicated above, embodiments of the present invention are aimed at providing a mechanism by which to improve engagement with patients for medication adherence. Some example embodiments may support the provision of a pharmacy intervention program that may employ a collection of business intelligence and outreach tools to facilitate contact with patients in a manner that is likely to improve medication adherence. In some embodiments, algorithms for identifying patients that are to be contacted under the pharmacy intervention program use a claims edit process. As such, for example, claims data may be analyzed longitudinally in a master patient index in order to identify patients for the pharmacy intervention program. Some example embodiments may further enable the use of automated contact mechanisms in order to contact the patients themselves and professionals that can interact with the patients to help improve medication adherence.

Failures in medication adherence can be very costly to the health care industry. Failure to take medications in accordance with instructions may obviously cause wastage with respect to medications not taken or not taken in a manner that is likely to be effective. However, the costs of failures in medication adherence also extends to cover the costs of complications that arise from failure to adhere and/or the costs of recurrence or lingering of illness and the subsequent treatments that may continue or even expand. In some cases, failures in medication adherence can be traced to a lack of comprehension of the drug regimen or a lack of motivation. These failures may be prevented or mitigated by direct engagement with the patients, for example, in the form of an enhanced consultation with a health care professional (e.g., a pharmacist). However, for example, a pharmacist's time is not unlimited and neither are the funding sources for paying for the pharmacist's time. Thus, it may be desirable to provide a mechanism by which to identify the best candidates for an enhanced intervention. Some examples of the present invention may utilize claims data, not dispense data, to determine which candidates are best for improving medication adherence with an enhanced intervention according to a pharmacy intervention program.

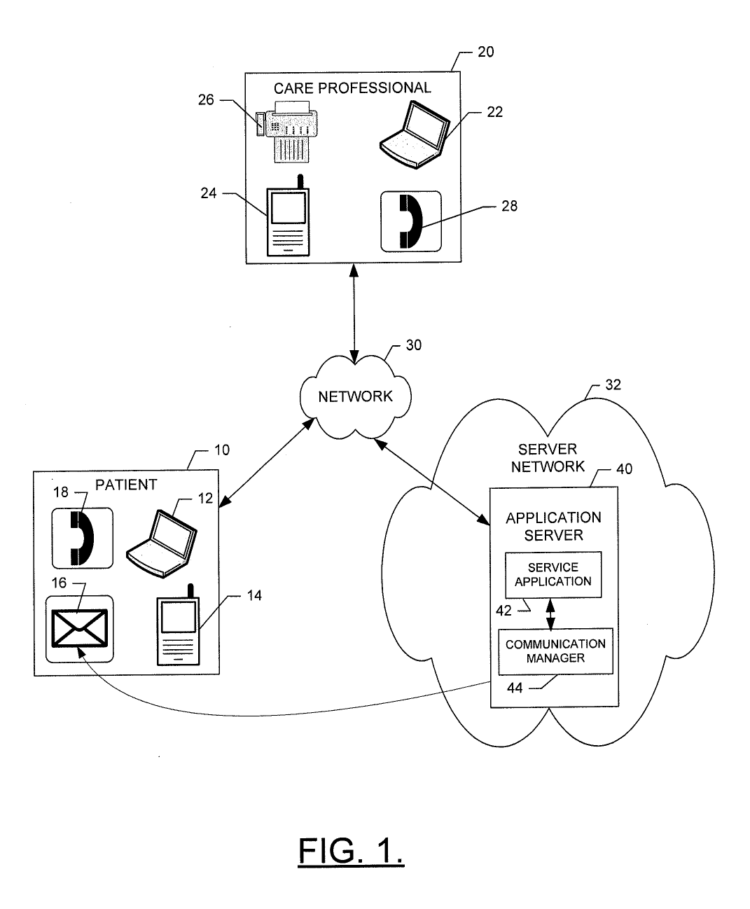

An example embodiment will now be described in reference to FIG. 1, which illustrates an exemplary system in which an embodiment of the present invention may be employed. Of note, the example of FIG. 1 is provided to illustrate several, but not all examples of devices and system architectures that may employ example embodiments. Thus, some examples may include more or less components than those which are shown in FIG. 1. As shown in FIG. 1, a system according to an exemplary embodiment may include one or more patients (e.g., patient 10) that may, in some cases, be reachable via various different modes of communication. For example, the patient 10 may have a personal computer (PC) or laptop computer 12 via which email messages or other multimedia messages may be received. Alternatively or additionally, the patient 10 may have a mobile telephone, personal digital assistant or other mobile communication device 14 that may receive phone calls, text messages, emails or other communications. The patient 10 may also or alternatively be reachable by regular mail 16 or via landline telephone 18. As such, with respect to phone calls and various types of electronic messaging, the patient 10 may generally be reachable by sending messages over a network 30.

The network 30 may be a data network, such as a local area network (LAN), a metropolitan area network (MAN), a wide area network (WAN) (e.g., the Internet), and/or the like. However, in some cases, the network 30 may be a wired or wireless telephone network. As such, communication between the network 30, the patients and the other devices or databases (e.g., servers) to which the network 30 may be coupled can be accomplished by either wireline or wireless communication mechanisms and corresponding protocols.

In some embodiments, the network 30 may also be connected to, or be capable of providing a connection to, a care professional 20 such as a doctor's office, hospital, pharmacy, insurance provider, care manager, or other healthcare related service professional. The care professional 20 may also have access to one or more of the modes of communication described above. The care professional 20 may also be associated with one or more different communication devices that may be used to contact the care professional 20 in connection with example embodiments and/or provide information to the care professional 20 about one or more patients. Some examples of communication devices that may be associated with the care professional 20 may include a personal computer (PC) or laptop computer 12 (or other computer terminal) via which email messages or other multimedia messages may be received, and a mobile telephone, personal digital assistant or other mobile communication device 14 that may receive phone calls, text messages, emails or other communications. Other examples of communication devices may include a fax machine 26 and a landline telephone 28.

In an exemplary embodiment, devices to which the network 30 may be coupled may include one or more application servers (e.g., application server 40), which may form respective elements of a server network 32. Although the application server 40 is referred to as a “server”, this does not necessarily imply that it is embodied on a single device. As such, for example, a server may include a server bank or multiple servers. Moreover, a server could simply be a computer or other computing device acting in a server capacity with respect to the provision of a service to another device (e.g., a communication device of the patient 10 or the care professional 20) without being a blade server including rack units and/or the like. The application server 40 may include hardware and/or software for configuring the application server 40 to perform various functions. As such, for example, the application server 40 may include processing logic and memory enabling the application server 40 to access and/or execute stored computer readable instructions for performing various functions. In an exemplary embodiment, one function that may be provided by the application server 40 may be the provision of any of a plurality of services with respect to the patient 10 and/or the care professional 20. As such, in various exemplary embodiments, certain operations and functionalities described herein in relation to the provision of targeted messaging for improved patient adherence may be fully implemented at one device, or may be implemented in a distributed fashion with different activities being shared between multiple devices. In some examples, the application server 40 may include a service application 42 comprising stored instructions for processing and/or accessing information and providing such information to various communication devices according to a specified mode of communication or providing data generated based on the processing of the information to various communication devices according to a specified mode of communication. For example, the service application 42 may be capable of directing placement of a telephone call, sending of an email or text message or otherwise contacting the patient 10 according to a specified mode of communication based on contact information associated with the patient 10.

In an example embodiment, the application server 40 may also host a communication manager 44 configured to determine specific modes of communication and communication parameters for use in contacting the patient 10 and/or the care professional 20 to improve medication adherence according to an example embodiment. As such, the communication manager 44 may utilize specific information about the patient 10 (and perhaps also a plurality of other patients) as determined via a claims edit process in order to identify patients to be engaged by the care professional 20 in a pharmacy intervention program interview. The care professional 20, and in some cases also the patient (e.g., patient 10), may then be contacted according to a communication plan to facilitate initiation of the interview and/or to facilitate medication adherence. In this regard, in some embodiments, the communication manager 44 may be configured to employ a candidate identifier 46 to select candidates for the pharmacy intervention program interview using claims information and then select a communication plan (e.g., based on actor characteristics and/or other related information) to implement via the service application 42 for executing phone calls, sending emails, sending text messages, sending faxes or other electronic communications to the patient 10 and/or the care professional 20.

In some embodiments, rather than being hosted by a server, the communication manager 44 may be hosted by a PC or other computer associated with an organization engaged in healthcare related service provision. Thus, in some cases, the communication manager 44 could even be hosted at a computer associated with the care professional 20. However, in some embodiments, the communication manager 44 may be associated with a third party providing a service associated with facilitating operation of the pharmacy intervention program.

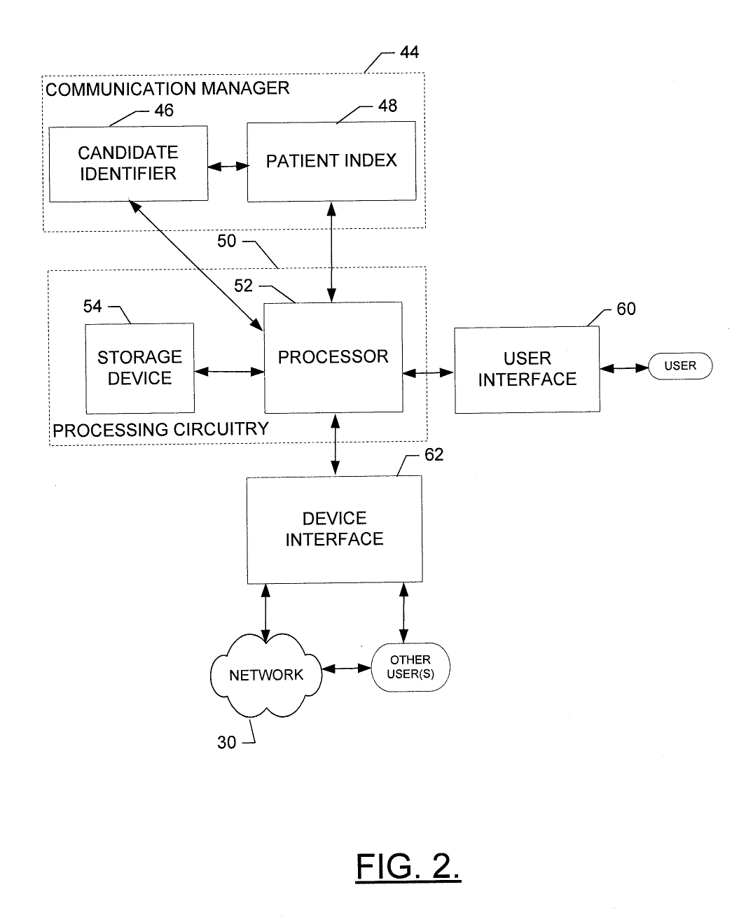

An exemplary embodiment of the invention will now be described with reference to FIG. 2. FIG. 2 shows certain elements of an apparatus for facilitating pharmacy intervention program interviewing for improved medication adherence according to an exemplary embodiment. The apparatus of FIG. 2 may be employed, for example, on any of a variety of communication devices (such as, for example, a network device, server, proxy, or the like (e.g., the application server 40 of FIG. 1)). Alternatively, embodiments may be employed on a combination of devices. Accordingly, some embodiments of the present invention may be embodied wholly at a single device (e.g., the application server 40) or by devices in a client/server relationship (e.g., the application server 40 and one or more clients distributed through the network 30). Furthermore, it should be noted that the devices or elements described below may not be mandatory and thus some may be omitted in certain embodiments.

Referring now to FIG. 2, an apparatus for facilitating pharmacy intervention program interviewing for improved medication adherence is provided. The apparatus may include or otherwise be in communication with processing circuitry 50 that is configured to perform data processing, application execution and other processing and management services according to an exemplary embodiment of the present invention. In one embodiment, the processing circuitry 50 may include a processor 52, a storage device 54 that may be in communication with or otherwise control a user interface 60 and a device interface 62. As such, the processing circuitry 50 may be embodied as a circuit chip (e.g., an integrated circuit chip) configured (e.g., with hardware, software or a combination of hardware and software) to perform operations described herein. However, in some embodiments, the processing circuitry 50 may be embodied as a portion of a server, computer, laptop, workstation or even one of various mobile computing devices. In situations where the processing circuitry 50 is embodied as a server or at a remotely located computing device, the user interface 60 may be disposed at another device (e.g., at a computer terminal or client device) that may be in communication with the processing circuitry 50 via the device interface 62 and/or a network (e.g., network 30).

The user interface 60 may be in communication with the processing circuitry 50 to receive an indication of a user input at the user interface 60 and/or to provide an audible, visual, mechanical or other output to the user. As such, the user interface 60 may include, for example, a keyboard, a mouse, a joystick, a display, a touch screen, a microphone, a speaker, and/or other input/output mechanisms. In an exemplary embodiment in which the apparatus is embodied as a server (e.g., the application server 40) or some other network devices, the user interface 60 may be fully implemented, limited, remotely located or eliminated.

The device interface 62 may include one or more interface mechanisms for enabling communication with other devices and/or networks. In some cases, the device interface 62 may be any means such as a device or circuitry embodied in either hardware, or a combination of hardware and software that is configured to receive and/or transmit data from/to a network and/or any other device or module in communication with the processing circuitry 50. In this regard, the device interface 62 may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an exemplary embodiment, the storage device 54 may include one or more non-transitory memory devices such as, for example, volatile and/or non-volatile memory that may be either fixed or removable. The storage device 54 may be configured to store information, data, applications, instructions or the like for enabling the apparatus to carry out various functions in accordance with exemplary embodiments of the present invention. For example, the storage device 54 could be configured to buffer input data for processing by the processor 52. Additionally or alternatively, the storage device 54 could be configured to store instructions for execution by the processor 52. As yet another alternative, the storage device 54 may include one of a plurality of databases that may store a variety of files, contents or data sets. Among the contents of the storage device 54, applications (e.g., service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an exemplary embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to embodiments of the present invention while configured accordingly. Thus, for example, when the processor 52 is embodied as an ASIC, FPGA or the like, the processor 52 may be specifically configured hardware for conducting the operations described herein. Alternatively, as another example, when the processor 52 is embodied as an executor of software instructions, the instructions may specifically configure the processor 52 to perform the operations described herein.

In an exemplary embodiment, the processor 52 (or the processing circuitry 50) may be embodied as, include or otherwise control the communication manager 44. The communication manager 44 may be configured to access information from various sources and utilize the information to select a communication plan for sending targeted messaging for improved patient adherence to a patient and/or the care professional 20. In an example embodiment, the communication manager 44 may include or otherwise communicate with a candidate identifier 46.

The candidate identifier 46 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the candidate identifier 46 as described herein.

The candidate identifier 46 may be configured to apply a set of logic rules to data corresponding to claims that pharmacies submit to payers to determine patient eligibility for an advanced consult or interview to improve medication adherence. As such, the candidate identifier 46 may provide a pharmacy claims switch exchange to extend the capability for candidate identification with the application of relatively complex logical rules that can be applied quickly to identify candidates and inform care professionals of the identity of the candidates prior to an upcoming interaction between the care professional and the identified candidate.

In an example embodiment, the candidate identifier 46 may be configured to receive information such as refill number, insurance type, longitudinal prescription information and other adherence data to determine whether a particular patient (e.g., patient 10) should be considered to be a candidate for an enhanced interview with the pharmacist when the patient comes to pick up medication associated with a particular prescription. As such, generally speaking, the candidate identifier 46 may be configured to use claims data (e.g., data received from a claims processing system or in connection with pharmacy submissions to payers) including at least patient information and medication information to determine patient eligibility for the enhanced interview. The patient data may include information regarding the patient's past history for adherence and/or prescriptions, the insurance of the patient, and/or the like. Meanwhile, the medication information may include information on the particular medication prescribed and perhaps also the refill number for the medication.

In some embodiments, the candidate identifier 46 may apply business logic rules to the medication information and patient information to identify whether the patient is a candidate for an enhanced interview. As such, for example, the candidate identifier 46 may be configured to apply rules relating to eligibility criteria that are defined on the basis of medication type and insurance coverage. In some embodiments, rules may be established to apply weights or scores to patients to determine which patients (e.g., those with weights or scores meriting selection as a candidate) are to be selected for an enhanced interview during which detailed information on drug regimen, instructions, precautions and/or encouragement may be provided to the selected patients. The rules (or weights or scores associated therewith) may be biased to selection of individuals who have a highest likelihood of benefit from the enhanced interview or individuals with insurance plans that favor such interviews. Thus, for example, a patient receiving a first time prescription for a particular medication may be more likely to be selected for an enhanced interview than a patient that is merely getting a refill. Similarly, in some examples, a patient with a poor history of adherence may be selected for an enhanced interview since such an interview may not be needed for a patient with a good history of adherence.

Example embodiments may therefore provide a rule based system to identify candidates to receive an enhanced interview from a professional such as a pharmacist. However, example embodiments may use claims data rather than dispense data so that a patient-based and not pharmacy-based system may be created. A pharmacy-based system that uses dispense data may misidentify patients since, while it may be the first time that a patient refills a prescription at a particular pharmacy, the patient may have a long history with taking the medication but filling prescriptions from another pharmacy. Using claims data, the patient's longitudinal prescription history may be known even though it is the patient's first time at any particular pharmacy. Longitudinal prescription history information and any other claims data that is associated with a particular patient may be stored in a patient index 48 that may be accessed by the candidate identifier 46 to determine patient information and supplement patient information by updating the patient index 48 for each additional prescription for which a claim is made.

The patient index 48, which may be a portion of the storage device 54 or some other memory accessible to the processor 52, may store claims history information and other data indicative of each patient for which records are available. Moreover, since the information stored is stored in association with each respective patient, the information for each patient may include claims data that corresponds to prescriptions filled at any of a plurality of different pharmacies. In an example embodiment, the claims processing performed by the candidate identifier 46 may be made in a relatively quick time (e.g., on the order of milliseconds). Thus, for example, the processor 52 may process patient information and determine whether a particular patient is a candidate for an enhanced interview with the pharmacist (e.g., the care professional 20) prior to the arrival of the particular patient at the pharmacy to pick up the corresponding medication.

After a patient (e.g., patient 10) has been identified as a candidate for an enhanced interview with the care professional 20, the patient 10 and/or the care professional 20 may receive notifications or other communications associated with the enhanced interview. In an example embodiment, communications may be facilitated by the communication manager 44. In an example embodiment, the communication manager 44 may be configured to direct the generation and/or selection of messages and/or materials to be provided to the patient 10 and/or the care professional 20. The communication manager 44 may also be configured to select a communication mechanism to be employed for such communications. Thus, for example, the communication manager 44 may be configured to select one or more of the laptop computer 12, the mobile communication device 14, regular mail 16 or the landline telephone 18 as a mechanism by which to provide messages and/or materials to the patient 10 in relation to the selection of the patient 10 as a candidate for the enhanced interview. Similarly, the communication manager 44 may be configured to select one or more of the laptop computer 22, the mobile communication device 24, the fax machine 26 or the landline telephone 28 as a mechanism by which to provide messages and/or materials to the care professional 20 in relation to the enhanced interview.

In an example embodiment, the communication manager 44 may be configured to generate or select messages and/or materials that may be tailored to the patient 10 based on information determined from the patient index 48, for delivery to the patient 10. The messages and/or materials may include notifications (e.g., that the patient 10 has been selected for an enhanced interview with the care professional 20), directions (e.g., to proceed to a particular window or location in the pharmacy to conduct the enhanced interview or on picking up and/or taking medications prescribed), marketing materials, coupons, educational material (e.g., explaining activities and/or lifestyle changes that may impact the patient's disease or condition), alerts, and/or the like. In some cases, coupons may be provided with a barcode that can be printed out or read from a display of the mobile communication device 14 of the patient.

In some cases, the communication manager 44 may also be configured to generate or select messages and/or materials that are tailored to the patient 10, for delivery to the care professional 20 (e.g., a pharmacist). Thus, for example, the pharmacist may receive a notification that a particular patient is coming to the pharmacy to pick up medicine and that the particular patient should receive an enhanced interview. In some cases, the notification may include materials (e.g., educational, marketing, coupons, directions, etc.) that the pharmacist is to provide to the particular patient or to use in counseling the particular patient during the enhanced interview. In an example embodiment, the pharmacist may carry a mobile communication device 24 and may receive text messages or emails identifying patients that will arrive for an enhanced interview. The pharmacist may send a return message when the enhanced interview is completed to enable updating of the patient index 48 to indicate that the patient received an enhanced interview for the corresponding prescription. The return message may also be used for billing purposes to enable the pharmacist's time to be compensated (e.g., via insurance or other payment methods). In an example embodiment, the pharmacist may receive a fax message directing conduct of the enhanced interview. The fax message may be attached to a bag associated with the filled prescription. When the patient arrives, the pharmacist may ask the patient if they would like to receive the enhanced interview (or otherwise conduct the interview), and then sign a portion (or the back) of the fax message and send it back to an entity associated with the communication manager 44 to indicate completion of the interview.

Example embodiments may provide for selection of patients that are good candidates for receiving an enhanced interview based on claims data rather than dispense data to provide a patient-based tracking system that is useful across many organizations. The enhanced interview may itself be a billable activity that may be billed to a healthcare related entity (e.g., a hospital, insurance company, doctor's office, or third party care manager). In some cases these costs may be covered by insurance or passed on to the consumer. However, in other cases, hospitals, doctor's offices or third party care managers may cover such costs themselves in light of expected savings associated with more efficient operation of the healthcare industry as a whole. Example embodiments may also enable numerous mechanisms by which engagement may be conducted with patients in order to increase medication adherence. Thus, example embodiments may improve healthcare quality and reduce healthcare costs by improving medication adherence and therefore also improving the effectiveness of treatment regimens.

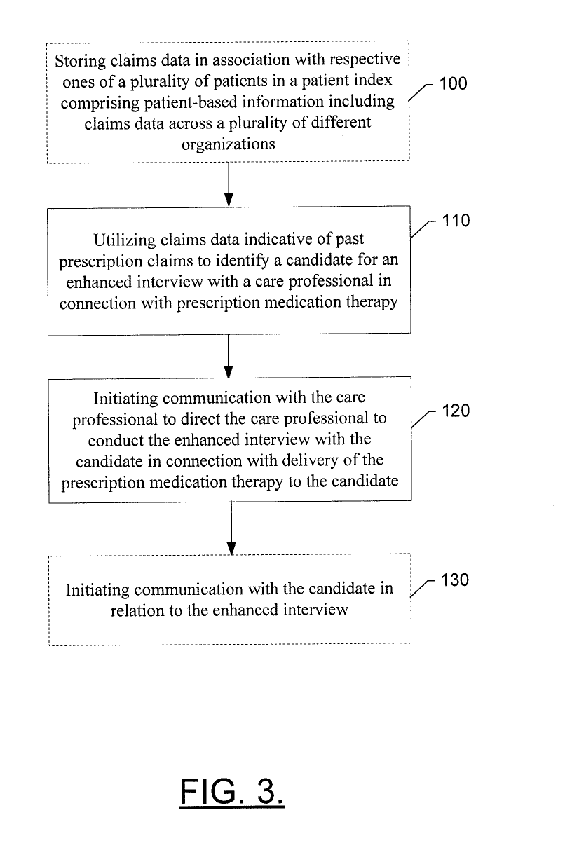

Embodiments of the present invention may therefore be practiced using an apparatus such as the one depicted in FIG. 2 within the overall system depicted in FIG. 1. However, it should be appreciated that some embodiments may be practiced in connection with a computer program product for performing embodiments of the present invention. FIG. 3 is a flowchart of a method and program product according to exemplary embodiments of the invention. Each block of the flowchart of FIG. 3, and combinations of blocks in the flowchart, may be implemented by various means, such as hardware, firmware, processor, circuitry and/or another device associated with execution of software including one or more computer program instructions. Thus, for example, one or more of the procedures described above may be embodied by computer program instructions, which may embody the procedures described above and may be stored by a storage device (e.g., storage device 54) and executed by processing circuitry (e.g., processor 52). The operations of FIG. 3 may define operations for the execution of an algorithm for improving patient medication adherence. Furthermore, it should be noted that any of the operations of FIG. 3 may be repeated in some embodiments in order to define a cyclical mechanism by which repeated attempts at improving patient behavior in a targeted manner may be implemented.

As will be appreciated, any such stored computer program instructions may be loaded onto a computer or other programmable apparatus (i.e., hardware) to produce a machine, such that the instructions which execute on the computer or other programmable apparatus implement the functions specified in the flowchart block(s). These computer program instructions may also be stored in a non-transitory computer-readable medium comprising memory that may direct a computer or other programmable apparatus to function in a particular manner, such that the instructions stored in the computer-readable memory produce an article of manufacture including instructions to implement the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

In this regard, a method according to one example embodiment of the invention, as shown in FIG. 3, may include utilizing claims data indicative of past prescription claims to identify a candidate for an enhanced interview with a care professional in connection with prescription medication therapy at operation 110. The method may further include initiating communication with the care professional to direct the care professional to conduct the enhanced interview with the candidate in connection with delivery of the prescription medication therapy to the candidate at operation 120.

In some embodiments, certain ones of the operations above may be modified or further amplified as described below. Moreover, in some embodiments additional optional operations may also be included (some examples of which are shown in dashed lines in FIG. 3). It should be appreciated that each of the modifications, optional additions or amplifications below may be included with the operations above either alone or in combination with any others among the features described herein. In some embodiments, the method may further include storing claims data in association with respective ones of a plurality of patients in a patient index comprising patient-based information including claims data across a plurality of different organizations at operation 100. In some embodiments, the method may further include initiating communication with the candidate in relation to the enhanced interview at operation 120. In such an example, initiating communication with the candidate may include sending a coupon or marketing materials to the candidate via a mobile communication device. In an example embodiment, initiating communication with the care professional may include sending a message to a mobile communication device associated with a pharmacist to direct the pharmacist to conduct the enhanced interview with the candidate when the candidate attempts to pick up a prescription. In some embodiments, utilizing claims data indicative of past prescription claims to identify the candidate may include identifying the candidate based on drug, insurer or refill status associated with the current prescription. In an example embodiment, initiating communication with the care professional may include sending a message to the care professional including materials to be used in connection with the enhanced interview.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
utilizing claims data indicative of past prescription claims to identify a candidate for an enhanced interview with a care professional in connection with prescription medication therapy; and
initiating communication with the care professional to direct the care professional to conduct the enhanced interview with the candidate in connection with delivery of the prescription medication therapy to the candidate.

2. The method of claim 1, further comprising storing claims data in association with respective ones of a plurality of patients in a patient index comprising patient-based information including claims data across a plurality of different organizations.

3. The method of claim 1, wherein initiating communication with the care professional comprises sending a message to a mobile communication device associated with a pharmacist to direct the pharmacist to conduct the enhanced interview with the candidate when the candidate attempts to pick up a prescription.

4. The method of claim 1, further comprising initiating communication with the candidate in relation to the enhanced interview.

5. The method of claim 4, wherein initiating communication with the candidate comprises sending a coupon or marketing materials to the candidate via a mobile communication device.

6. The method of claim 1, wherein initiating communication with the care professional comprises sending a message to the care professional including materials to be used in connection with the enhanced interview.

7. The method of claim 1, wherein utilizing claims data indicative of past prescription claims to identify the candidate comprises identifying the candidate based on drug, insurer or refill status associated with a current prescription associated with the prescription medication therapy.

8. An apparatus comprising processing circuitry configured to:
utilize claims data indicative of past prescription claims to identify a candidate for an enhanced interview with a care professional in connection with prescription medication therapy; and
initiate communication with the care professional to direct the care professional to conduct the enhanced interview with the candidate in connection with delivery of the prescription medication therapy to the candidate.

9. The apparatus of claim 8, wherein the processing circuitry is further configured to store claims data in association with respective ones of a plurality of patients in a patient index comprising patient-based information including claims data across a plurality of different organizations.

10. The apparatus of claim 8, wherein the processing circuitry is configured to initiate communication with the care professional by sending a message to a mobile communication device associated with a pharmacist to direct the pharmacist to conduct the enhanced interview with the candidate when the candidate attempts to pick up a prescription.

11. The apparatus of claim 8, wherein the processing circuitry is further configured to initiate communication with the candidate in relation to the enhanced interview.

12. The apparatus of claim 11, wherein the processing circuitry is configured to initiate communication with the candidate by sending a coupon or marketing materials to the candidate via a mobile communication device.

13. The apparatus of claim 8, wherein the processing circuitry is configured to initiate communication with the care professional by sending a message to the care professional including materials to be used in connection with the enhanced interview.

14. The apparatus of claim 8, wherein the processing circuitry is configured to utilize claims data indicative of past prescription claims to identify the candidate by identifying the candidate based on drug, insurer or refill status associated with a current prescription associated with the prescription medication therapy.

15. A computer program product comprising at least one computer-readable storage medium having computer-executable program code instructions stored therein, the computer-executable program code instruction comprising program code instructions for:
utilizing claims data indicative of past prescription claims to identify a candidate for an enhanced interview with a care professional in connection with prescription medication therapy; and
initiating communication with the care professional to direct the care professional to conduct the enhanced interview with the candidate in connection with delivery of the prescription medication therapy to the candidate.

16. The computer program product of claim 15, further comprising program code instructions for storing claims data in association with respective ones of a plurality of patients in a patient index comprising patient-based information including claims data across a plurality of different organizations.

17. The computer program product of claim 15, wherein program code instructions for initiating communication with the care professional include instructions for sending a message to a mobile communication device associated with a pharmacist to direct the pharmacist to conduct the enhanced interview with the candidate when the candidate attempts to pick up a prescription.

18. The computer program product of claim 15, further comprising program code instructions for initiating communication with the candidate in relation to the enhanced interview.

19. The computer program product of claim 18, wherein program code instructions for initiating communication with the candidate include instructions for sending a coupon or marketing materials to the candidate via a mobile communication device.

20. The computer program product of claim 15, wherein program code instructions for initiating communication with the care professional include instructions for sending a message to the care professional including materials to be used in connection with the enhanced interview.

21. The computer program product of claim 15, wherein program code instructions utilizing claims data indicative of past prescription claims to identify the candidate include instructions for identifying the candidate based on drug, insurer or refill status associated with a current prescription associated with the prescription medication therapy.
